(19) United States
(12) Patent Application Publication
(10) Pub. No.: US 2019/0013962 A1
(43) Pub. Date: Jan. 10, 2019

(54) MODULAR COMMUNICATION FRAMEWORK

(71) Applicant: BLOCKS WEARABLES INC., Los Angeles, CA (US)

(72) Inventors: Karl Taylor, Los Angeles, CA (US); Aksat SHAH, Los Angeles, CA (US)

(73) Assignee: BLOCKS WEARABLES INC., Los Angeles, CA (US)

(21) Appl. No.: 16/067,396

(22) PCT Filed: Dec. 29, 2016
(86) PCT No.: PCT/US2016/069223

§ 371 Date: Jun. 29, 2018

Related U.S. Application Data
(60) Provisional application No. 62/274,038, filed on Dec. 31, 2015.
(60) Provisional application No. 62/274,040, filed on Dec. 31, 2015.
(60) Provisional application No. 62/274,043, filed on Dec. 31, 2015.

(51) Int. Cl. H04L 12/40; H04L 12/403; G06F 13/26; H04L 12/861

(52) U.S. Cl. CPC H04L 12/40143; H04L 49/9073; G06F 13/26; H04L 12/403

(57) ABSTRACT

Implementations generally relate to providing addressing in a modular system. In some implementations, a method includes detecting one or more modules connected to a bus, where the one or more modules are uninitialized. The method further includes associating the one or more modules with a status address on the bus. The method further includes polling for one or more interrupts on the status address. The method further includes assigning one or more respective dynamic addresses to the one or more modules based on the one or more interrupts. Implementations also generally relate to facilitating communication in a modular system. Implementations also generally relate to facilitating general communication in a modular system.

### CROSS REFERENCE TO RELATED APPLICATIONS

This application is a U.S. national stage filing under 35 U.S.C. § 371 of International Application No. PCT/IB2016/069223, filed Dec. 29, 2016, which claims priority from U.S. Provisional Patent Application No. 62/274,038 entitled “DYNAMIC ADDRESSING AND HOT SWAPPING ON AN I2C BUS USING ACTIVE SLAVES,” filed Dec. 31, 2015; U.S. Provisional Patent Application No. 62/274,040 entitled “RAISING PRIORITIZED INTERRUPTS ON AN I2C BUS-PACKET HIJACK MECHANISM,” filed Dec. 31, 2015; U.S. Provisional Patent Application No. 62/274,043 entitled “MODULAR COMMUNICATION FRAMEWORK,” filed Dec. 31, 2015, which are hereby incorporated by reference as if set forth in full in this application for all purposes.

### BACKGROUND

Smart watches are computerized wristwatches that have various functions such as timekeeping, scheduling, and organizing. Smart watches may also have digital cameras and media players, as well as other functions. A smart watch provides a captive feature set and is typically a single unit that cannot be upgraded or changed.

### SUMMARY

Implementations generally relate to providing addressing in a modular system. In some implementations, a method includes detecting one or more modules connected to a bus, where the one or more modules are uninitialized. The method further includes associating the one or more modules with a status address on the bus. The method further includes polling for one or more interrupts on the status address. The method further includes assigning one or more respective dynamic addresses to the one or more modules based on the one or more interrupts.

With further regard to the method, in some implementations, the one or more modules are uninitialized if the one or more modules do not have dynamic addresses assigned to them. In some implementations, the status address is a globally shared address. In some implementations, the status address is a fixed address. In some implementations, the method further includes, responsive to the polling, receiving one or more polled interrupts from one or more of the respective modules. In some implementations, the method further includes, responsive to the polling, receiving one or more unique identifiers from the one or more respective modules. In some implementations, the one or more dynamic addresses are unique addresses.

In some embodiments, a computer-readable storage medium carries one or more sequences of instructions thereon. When executed by one or more processors, the instructions cause the one or more processors to perform operations including detecting one or more modules connected to a bus, where the one or more modules are uninitialized; associating the one or more modules with a status address on the bus; polling for one or more interrupts on the status address; and assigning one or more respective dynamic addresses to the one or more modules based on the one or more interrupts.

With further regard to the computer-readable storage medium, in some implementations, the one or more modules are uninitialized if the one or more modules do not have dynamic addresses assigned to them. In some implementations, the status address is a globally shared address. In some implementations, the status address is a fixed address. In some implementations, the instructions when executed further cause the one or more processors to perform operations including, responsive to the polling, receiving the one or more polled interrupts from one of the respective modules. In some implementations, the instructions when executed further cause the one or more processors to perform operations including, responsive to the polling, receiving one or more unique identifiers from the one or more respective modules. In some implementations, the one or more dynamic addresses are unique addresses.

In some implementations, a system includes one or more processors, and includes logic encoded in one or more non-transitory computer-readable storage media for execution by the one or more processors. When executed, the logic is operable to perform operations including detecting one or more modules connected to a bus, where the one or more modules are uninitialized; associating the one or more modules with a status address on the bus; polling for one or more interrupts on the status address; and assigning one or more respective dynamic addresses to the one or more modules based on the one or more interrupts.

With further regard to the system, in some implementations, the one or more modules are uninitialized if the one or more modules do not have dynamic addresses assigned to them. In some implementations, the status address is a globally shared address. In some implementations, the status address is a fixed address. In some implementations, the logic when executed is further operable to perform operations including, responsive to the polling, receiving one or more polled interrupts from one or more of the respective modules. In some implementations, the logic when executed is further operable to perform operations including, responsive to the polling, receiving one or more unique identifiers from the one or more respective modules.

Implementations generally relate to facilitating communication in a modular system. In some implementations, a method includes initiating communication with at least one first module on a bus, where the communication is initiated via a dynamic address that is associated with the at least one first module. The method further includes determining if at least a second module on the bus initiated an interrupt, where the determining is based on information at a status address, and where the status address is associated with the first module and the second module. The method further includes continuing communication with the at least one first module if no other module on the bus initiated an interrupt.

With further regard to the method, in some implementations, the initiating of the communication includes performing one or more write operations on the dynamic address. In some implementations, the dynamic address is a unique address. In some implementations, the determining if any other module on the bus initiated an interrupt includes performing one or more read operations on the status address. In some implementations, the status address is a globally shared address. In some implementations, the continuing of communication with the at least one first module includes transferring information via the dynamic address associated with the at least one first module. In some implementations, the continuing of communication with the at least one first module includes performing one or more read operations from the dynamic address.

In some embodiments, a computer-readable storage medium carries one or more sequences of instructions thereon. When executed by one or more processors, the instructions cause the one or more processors to perform operations including initiating communication with at least one first module on a bus, where the communication is initiated via a dynamic address that is associated with the at least one first module; determining if at least a second module on the bus initiated an interrupt, where the determining is based on information at a status address, and where the status address is associated with the first module and the second module; and continuing communication with the at least one first module if no other module on the bus initiated an interrupt.

With further regard to the computer-readable storage medium, in some implementations, the initiating of the communication includes performing one or more write operations on the dynamic address. In some implementations, the dynamic address is a unique address. In some implementations, to determine if any other module on the bus initiated an interrupt, the instructions when executed further cause the one or more processors to perform operations including performing one or more read operations on the status address. In some implementations, the status address is a globally shared address. In some implementations, to continue communication with the at least one first module, the instructions when executed further cause the one or more processors to perform operations including transferring information via the dynamic address associated with the at least one first module. In some implementations, to continue communication with the at least one first module, the instructions when executed further cause the one or more processors to perform operations including performing one or more read operations from the dynamic address.

In some implementations, a system includes one or more processors, and includes logic encoded in one or more non-transitory computer-readable storage media for execution by the one or more processors. When executed, the logic is operable to perform operations including initiating communication with at least one first module on a bus, where the communication is initiated via a dynamic address that is associated with the at least one first module; determining if at least a second module on the bus initiated an interrupt, where the determining is based on information at a status address, and where the status address is associated with the first module and the second module; and continuing communication with the at least one first module if no other module on the bus initiated an interrupt.

With further regard to the system, in some implementations, the initiating of the communication includes performing one or more write operations on the dynamic address. In some implementations, the dynamic address is a unique address. In some implementations, to determine if any other module on the bus initiated an interrupt, the logic when executed is further operable to perform operations including performing one or more read operations on the status address. In some implementations, the status address is a globally shared address. In some implementations, to continue communication with the at least one first module, the logic when executed is further operable to perform operations including transferring information via the dynamic address associated with the at least one first module.

Implementations generally relate to facilitating general communication in a modular system. In some implementations, a method includes receiving a request for data of a first data type. The method further includes determining data types supported by one or more respective modules on a bus, where the data types include the first data type. The method further includes selecting at least one of the modules to serve the data being requested. The method further includes providing the data of the first data type from the selected at least one module.

With further regard to the method, in some implementations, the data types include one or more vital sign data types. In some implementations, the data types include one or more positioning data types. In some implementations, the data types include one or more atmospheric data types. In some implementations, each module of the one or more respective modules is associated with one or more sets of functions, where each set of functions includes at least one data type function that supports a predetermined data type. In some implementations, the determining of the data types supported by the one or more respective modules includes: determining, for each of the modules, one or more associated sets of functions; and determining, for each of the sets of functions, one or more data types. In some implementations, the selecting is based on a predetermined priority policy. In some implementations, the method further includes enabling one or more of the modules to enter and wake up from a sleep mode.

In some embodiments, a computer-readable storage medium carries one or more sequences of instructions thereon. When executed by one or more processors, the instructions cause the one or more processors to perform operations including receiving a request for data of a first data type; determining data types supported by one or more respective modules on a bus, where the data types include the first data type; selecting at least one of the modules to serve the data being requested; and providing the data of the first data type from the selected at least one module.

With further regard to the computer-readable storage medium, in some implementations, the data types include one or more vital sign data types. In some implementations, the data types include one or more positioning data types. In some implementations, the data types include one or more atmospheric data types. In some implementations, each module of the one or more respective modules is associated with one or more sets of functions, and where each set of functions includes at least one data type function that supports a predetermined data type. In some implementations, to determine the data types supported by the one or more respective modules, the instructions when executed further cause the one or more processors to perform operations including: determining, for each of the modules, one or more associated sets of functions; and determining, for each of the sets of functions, one or more data types. In some implementations, the selecting is based on a predetermined priority policy. In some implementations, the instructions when executed further cause the one or more processors to perform operations including enabling one or more of the modules to enter and wake up from a sleep mode.

In some implementations, a system includes one or more processors, and includes logic encoded in one or more non-transitory computer-readable storage media for execution by the one or more processors. When executed, the logic is operable to perform operations including receiving a request for data of a first data type; determining data types supported by one or more respective modules on a bus, where the data types include the first data type; selecting at least one of the modules to serve the data being requested; and providing the data of the first data type from the selected at least one module.

With further regard to the system, in some implementations, the data types include one or more vital sign data types. In some implementations, the data types include one or more positioning data types. In some implementations, the data types include one or more atmospheric data types. In some implementations, each module of the one or more respective modules is associated with one or more sets of functions, and where each set of functions includes at least one data type function that supports a predetermined data type. In some implementations, to determine the data types supported by the one or more respective modules, the logic when executed is further operable to perform operations including: determining, for each of the modules, one or more associated sets of functions; and determining, for each of the sets of functions, one or more data types.

A further understanding of the nature and the advantages of particular implementations disclosed herein may be realized by reference of the remaining portions of the specification and the attached drawings.

### BRIEF DESCRIPTION OF THE DRAWINGS

FIG. 1 illustrates a block diagram of an example modular system, which may be used for implementations described herein.

FIG. 2 illustrates a block diagram of an example modular system, which may be used for implementations described herein.

FIG. 3 illustrates an example flow diagram for providing addressing in a modular system, according to some implementations.

FIG. 4 illustrates a block diagram of modules in association with a status address and dynamic addresses, according to some implementations.

FIG. 5 illustrates an example flow diagram for facilitating communication in a modular system, according to some implementations.

FIG. 6 illustrates an example data structure in the context of a write operation, according to some implementations.

FIG. 7 illustrates an example data structure in the context of a status check operation, according to some implementations.

FIG. 8 illustrates an example data structure in the context of a read operation, according to some implementations.

FIG. 9 illustrates an example priority table, according to some implementations.

FIG. 10 illustrates an example flow diagram for facilitating general communication in a modular system, according to some implementations.

FIG. 11 illustrates a block diagram of an example computing system, which may be used for some implementations described herein.

FIG. 12 illustrates a block diagram of an example computing system, which may be used for some implementations described herein.

FIG. 13 illustrates a block diagram of an example computing system, which may be used for some implementations described herein.

### DETAILED DESCRIPTION

Implementations described herein enable, facilitate, and manage communication in a modular system. As described in more detail herein, implementations generally relate to providing addressing in a modular system, and facilitate various communications in a modular system. For example, implementations enable a personal device such as a smart watch to provide sets of functions via modules that can be expanded, upgraded, and/or changed, and allows customization on a regular basis (e.g., a daily or weekly basis, etc.). In some implementations, the modules are physical units that can attach to and detach from the main body of the smart watch, wherein each module provides one or more functions that are served to a user via the smart watch.

In various implementations, the smart watch includes a core that communicates with one or more modules in a modular system. In some implementations, the core detects one or more modules connected to a bus, where the one or more modules are uninitialized. As described in more detail herein, the core associates the uninitialized modules with a globally shared status address on the bus. The core also polls for interrupts on the status address, and assigns respective dynamic addresses to the uninitialized modules based on the interrupts.

In some implementations, the core initiates communication with at least one module on a bus, where the communication is initiated via a dynamic address that is associated with the module. The core determines if any other modules on the bus initiated an interrupt based on information at a shared status address. The core continues communication with the module if no other module on the bus initiated an interrupt.

In some implementations, the core receives a request for data of a particular data type. The core determines data types supported by one or more modules on a bus. The core selects at least one of the modules to serve the data being requested, and provides the data of the particular data type from the selected module.

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

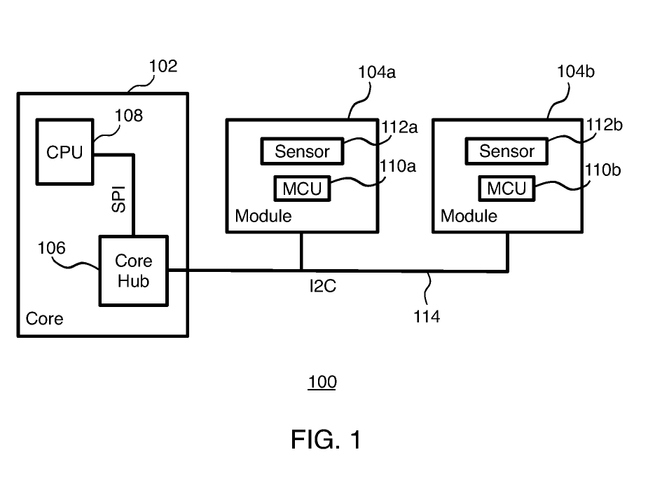

FIG. 1 illustrates a block diagram of an example modular system 100, which may be used for implementations described herein. As shown, modular system 100 includes a core 102, which communicates with one or more modules 104a, 104b, etc.

As shown, in various implementations, core 102 includes a core hub 106 and a core processor 108 (labeled “CPU”). Also, in various implementations, module 104a includes a processor 110a or microcontroller 110a (labeled “MCU”) and a sensor 112a. Similarly, module 104b includes a processor 110b or microcontroller 110b (labeled “MCU”) and a sensor 112b.

In various implementations, core 102 communicates with modules 104a, 104b, etc., via a bus 114. In some implementations, communication between processor 108 and a microcontroller of a given module (e.g., processor 110a, processor 110b, etc.) is primarily achieved using a modified version of inter-integrated circuit (I²C) technology. This is also achieved using core hub 106 (or any other suitable hub device.) In some implementations, bus 114 is an I²C bus. As described in more detail herein, core 102 is the master and core hub 106 of core 102 manages modules 104a, 104b, etc., which are slaves. In various implementations, core 102 initiates all conversations with the modules.

In various implementations, communication between core 102 and a module may operate in two modes. For example, communication may operate in a high-speed mode or a low-speed mode. In some implementations, communication occurs in the low-speed mode by default. In some implementations, high speed may be realized using a universal serial bus (USB). In some implementations, low speed may be realized using I²C. In some implementations, modules on the bus that have different speed requirements may operate simultaneously, where both USB and I²C are used. Implementations are not limited to these protocols.

As described in more detail herein, in order to remove the restriction of the limited I²C address space, the protocol uses dynamic addressing. Implementations support hot plugging of modules while the core device is powered on. Implementations also enable an individual module to interrupt the core and be addressed in a timely manner. These features are achieved by using a globally shared address between all modules in combination with the packet hijack mechanism described in more detail herein.

In some implementations, modular system 100 includes a modular framework that is responsible for responding to events on the communication bus, communicating with the modules, notifying applications of module events, and providing access methods for sensors (e.g., to third party developers, etc.).

In some implementations, modular system 100 implements a communication protocol that is used for communication between core 102 and modules 104a, 104b, etc. The communication protocol facilitates both a high-speed mode and a low-speed mode, permits for interrupts and module detection, and enables the waking of modules that are in a sleeping state.

In some implementations, modular system 100 includes a module platform that runs on each of the modules 104a, 104b, etc. A primary function of the module platform is to facilitate communication between core 102 and the modules 104a, 104b, etc. The module platform contains a boot loader that updates the device firmware and is extensible by module producers in order to run specific code for modules (e.g., of module producers, etc.).

In some implementations, core 102 includes a core operating system that serves a user experience suitable for various applications such as wearable devices. In some implementations, core hub 106 includes core hub firmware and manages modules (e.g., modules 102a, 104b, etc.). The core hub firmware is responsible for managing a communication bus, initializing and registering module states, and detecting events such as module connection and disconnection, or interrupts raised by modules.

In various implementations, modules are organized based on a hierarchical bus, where core 102 or more precisely core hub 106 is the master on the bus. In some implementations, the bus between core 102 and core hub 106 may be a serial peripheral interface (SPI) bus, but is not limited to an SPI bus. The specific type of bus may vary, depending on the specific implementation. In various implementations, core hub 106 determines which communication is happening between the modules at any given time. The core hub 106 being the master over the modules is advantageous for simple communications management. Each module functions as a self-contained peripheral. While implementations are described herein in the context of core hub 106 performing particular functions, another suitable component or other combination of components of modular system 100 or any suitable processor or processors associated with modular system 100 such as CPU 108 may perform implementations described herein. In various implementations, modular system 100 may not have all of the components shown in FIG. 1 and/or may have other elements including other types of components instead of, or in addition to, those shown herein.

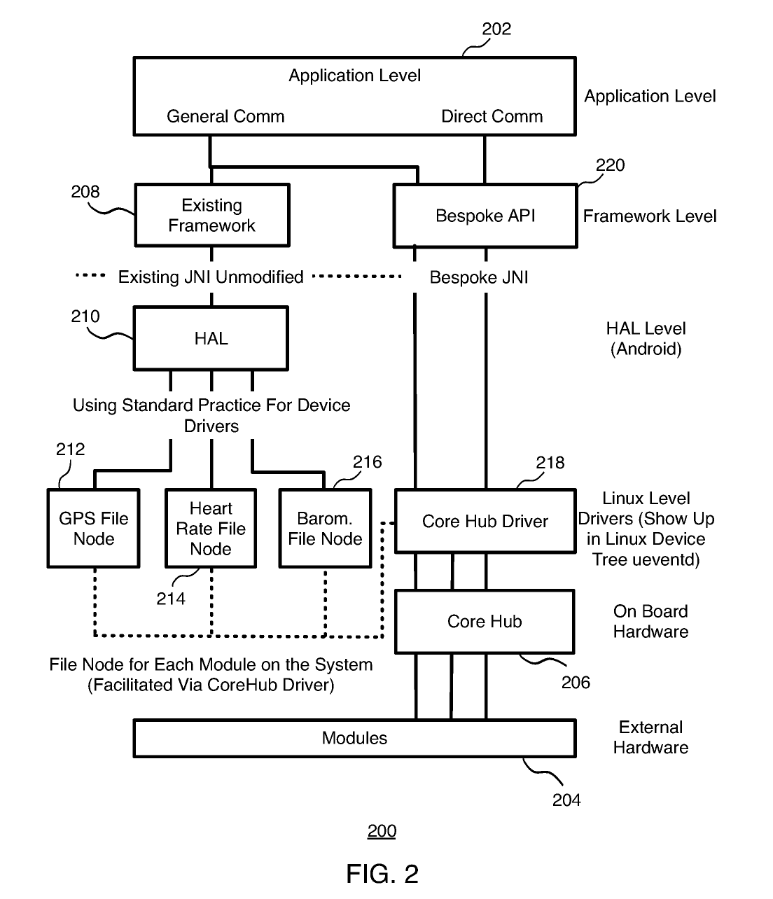

FIG. 2 illustrates a block diagram of an example modular system 200, which may be used for implementations described herein. Application level 202 communicates with modules 204 via core hub 206 along various data flow paths, which are described in more detail herein.

In some implementations, general communication flows via an existing framework, utilizing capabilities and control logic of the existing frameworks. In this scenario, the data flow path begins at the application level, passes through an existing framework 208, a hardware abstraction layer (HAL) 210, file nodes 212, 214, 216, etc., a core hub driver 218, and then through core hub 206.

In some implementations, where general communication flows via an existing framework, core hub 206 manages the modularity aspect, and sensor drivers hook into HAL 210. In various implementations, HAL 210 handles communication between the frameworks (which are used by apps) and the hardware. Core hub 206 encapsulates as much of the modularity as possible, such that an existing base operating system is unaware of the modularity. This enables application developers to easily build applications using prior knowledge of the operating system without being concerned about modules being disconnected, etc.

In some implementations, general communication flows via a bespoke application program interface (API). In some implementations, another data flow path begins at the application level, passes through a bespoke API 220, and then through core hub 206. This scenario also involves communication with sensors associated with file nodes 212, 214, 216, etc. In various implementations, this scenario enables a non-modular framework to function as a modular framework in that it enables developers to communication generally with the modules.

In some implementations, where general communication flows via a bespoke API 220, the bespoke API defines a set of capabilities that can be requested by applications. Modules may register the standard functions they support directly when requested (e.g., every module could have a function GET_SUPPORTED_DATA_TYPES, which returns the list of supported data types). When a certain capability is requested by an application, core hub driver 218 of core hub 206 interprets the capability and determines which standard functions it needs to call. The driver then requests a list of modules that support the given set of standard functions from core hub 206. Once a matching module is selected, information (e.g., raw data, etc.) can be requested from and provided by the module.

In some implementations, an application may register one or more of the following callbacks: query available capabilities, provide capability at interval, capability available (e.g., connection, etc.), capability unavailable (e.g., disconnection, etc.). As such, in this instance, the application registers to be notified on connection events, but at a higher level of abstraction (e.g., the application is not concerned with the particular module the application is communicating with), only that the particular data type is being returned.

In some implementations, direct communication flows via a bespoke API. In some implementations, another data flow path begins at the application level, passes through a bespoke API 220, and then through core hub 206. In various implementations, this scenario enables a non-modular framework to function as a modular framework in that it enables developers to communicate directly with the modules. Enabling direct communication with modules in turn allows for control of modules at a low level. For example, various implementations support various sensor functions associated with modules connected to the bus. As a result, core hub 206 may communicate with modules in order to collect data from any type of sensor associated with any given module.

In some implementations, where direct communication flows via a bespoke API, each module registers a particular model number (e.g., numeric identifier associated with particular model, etc.). Applications may request to communicate with a particular (range of) model number(s). Core hub 206 provides a response containing the set of modules that match the query along with a handle (e.g., numeric identifier, etc.) for use of each one. Then, subsequent direct calls via the bespoke API/framework may require the handle such that core hub 206 is aware which module to communicate with. These functions may be referred to as vendor functions.

In various implementations, in contrast to using a standard fixed hardware-addressing system (e.g., between address 1 and address 126, etc.), the core uses dynamic addressing using active slaves, which enables hot swapping of modules. In some implementations, the core may use dynamic addressing without prioritized interrupts (e.g., polling) to enable hot swapping of modules.

Referring again to FIG. 1, in various implementations, when a given module (e.g., module 104a, module 104b, etc.) is first connected to bus 114 of modular system 100, the module is not yet initialized and needs to be initialized in order to communicate with core 102. In some implementations, to request initialization, the module raises an interrupt with core hub 106 and waits to be assigned a dynamic address.

As indicated herein, implementations enable newly connected (“active”) modules to negotiate a dynamic address with core 102 (the master) and to enable future communication between core 102 and the modules. This removes the hard limit of the number of modules that can be produced. After initialization, the module will then have two slave addresses, its dynamic address and the general status address (which all modules share).

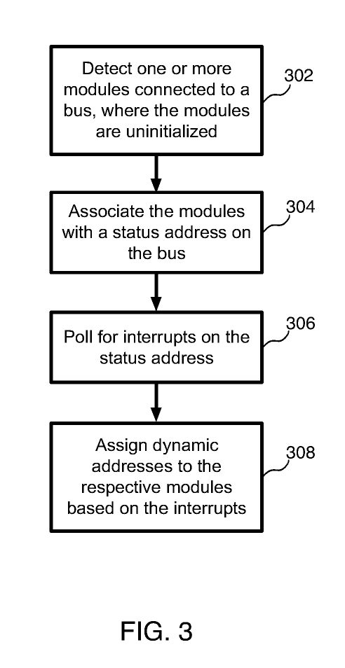

FIG. 3 illustrates an example flow diagram for providing addressing in a modular system, according to some implementations. Referring to both FIGS. 1 and 3, a method is initiated at block 302, where core 102 detects one or more modules connected to bus 114. In these example implementations, each of the modules is uninitialized. In various implementations, one or more modules are uninitialized if the one or more modules do not have dynamic addresses assigned to them. For example, a particular module is uninitialized if the particular module does not have a dynamic address assigned to it. For example, a particular module may not have a dynamic address assigned or allocated to it if the module is newly connected to the bus. It is possible that some modules that are newly connected (e.g., physically coupled to the bus or wirelessly coupled to the bus) to the bus are uninitialized (e.g., have no dynamic addresses assigned), while other existing modules connected to the bus are initialized (e.g., have dynamic addresses assigned).

In various implementations, core 102 may detect a new module connected to the bus in various ways. For example, in some implementations, a new module may send a signal to core 102 via the bus to indicate the module's presence. As described in more detail herein, a module may initiate an interrupt by sending an interrupt signal to core 102, where an interrupt indicates that a given corresponding module is uninitialized and needs a dynamic address. In some implementations, core 102 may periodically send signals to different dynamic addresses to detect responses. In some implementations, one or more sensors may be used to detect new modules on the bus, and to inform core 102 of any newly connected modules.

In various implementations, every component (e.g., modules, etc.) on the bus contains its own MCU, which is used for address and conflict resolution.

At block 304, core 102 associates the one or more uninitialized modules with a status address on the bus. In various implementations, the status address is a globally shared address in that multiple modules or all modules share the same status address. In other words, core 102 assigns the same status address to all modules.

Various implementations are described herein in the context of a single status address that is associated with all modules. Other alternative implementations are possible. For example, in some implementations, core 102 may utilize multiple status addresses (e.g., 2 status addresses, 3 status addresses, etc.), where implementations described herein apply to multiple status address. For example, in block 306 described herein, core 102 may poll for interrupts on multiple status addresses substantially simultaneously. Such a scheme may be useful, for example, if one or more types of modules are associated with a first status address, and one or more other types of modules are associated with a second status address. As such, each status address may be shared by multiple modules. In some implementations, different status addresses may have different priorities, where core 102 is first interrupted by the status address with a higher priority.

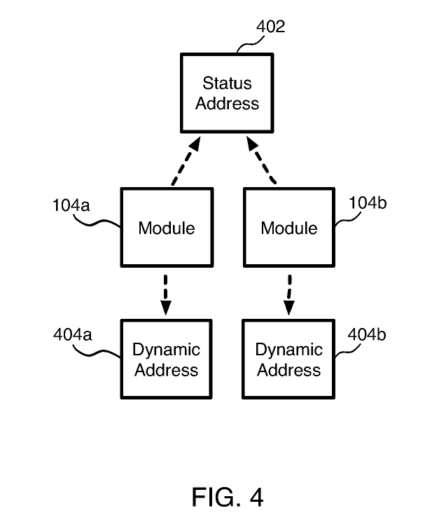

FIG. 4 illustrates a block diagram of modules 104a and 104b in association with a status address 402 and dynamic addresses 404a and 404b, according to some implementations. As shown, core 102 associates both module 104a and module 104b to the same globally shared status address 402. In other words, core 102 assigns the same status address to multiple or all modules. As indicated herein, in various implementations, the status address is a fixed bus address. For example, in various implementations, the status address need not change, where the same status address on the bus is used for all modules. Initially, every module uses the same fixed status address. As described in more detail herein, core 102 associates module 104a to a unique dynamic address 404a, and associates module 104b to a unique dynamic address 404b.

At block 306, core 102 polls for one or more interrupts on the status address. In some implementations, core 102 polls the status address at predetermined intervals. In some implementations, core 102 polls the status address when a module sets an interrupt on the status address. In some implementations, when core 102 polls the status address, each uninitialized module responds with an interrupt followed by its unique software address.

In some implementations, in response to the polling, core 102 receives one or more polled interrupts from one or more of the uninitialized modules, respectively. In some implementations, core 102 may detect interrupts at the status address one at a time. In some implementations, multiple interrupts may be stored in a buffer, thereby enabling core 102 to handle multiple interrupts as they are received.

In some implementations, also in response to the polling, core 102 also receives unique identifiers from the uninitialized modules, respectively. In various implementations, each interrupt indicates that a given corresponding module is uninitialized and needs a dynamic address. In some implementations, the interrupt is a high-priority interrupt. In some implementations, each module has a unique address for a module type, which enables multiple modules of the same type to be present on the bus.

In various implementations, if core 102 receives at least one interrupt, core 102 may temporarily halt normal routines in order to initialize one or more newly uninitialized modules.

At block 308, core 102 assigns one or more respective dynamic addresses to the one or more uninitialized modules based on the interrupts. In various implementations, the dynamic addresses are unique addresses. As such, each module is assigned or allocated a unique dynamic address. For example, referring still to FIG. 4, core 102 associates each of modules 104a and 104b to a unique dynamic address. As shown, module 104a is associated with dynamic address 404a, and module 104b is associated with dynamic address 404b.

As indicated herein, core 102 assigns one or more respective dynamic addresses to the one or more uninitialized modules based on the interrupts. For example, in various implementations, core 102 assigns the uninitialized modules with dynamic addresses based on slave arbitration. For example, in various implementations, to ensure that each module is served with a unique dynamic address, core 102 requires that each module provide to core 102 a unique software identifier/address. As such, before assigning dynamic addresses to particular uninitialized modules, core 102 distinguishes among different uninitialized modules based on their unique software addresses. Core 102 serves each uninitialized module with a dynamic address, e.g., one at a time, in order to ensure that each module is assigned a unique dynamic address. In some implementations, such assignment of dynamic addresses may occur on a first come first served basis or other suitable priority sequence or scheme (e.g., based on when the respective interrupts from each module was received, etc.). After assigning dynamic addresses to those particular initialized modules, core 102 distinguishes among the different (now initialized modules) based on their unique dynamic addresses.

In some implementations, the bus has open-drain circuitry. The open-drain nature of the bus may be used to facilitate dynamic addressing. By exploiting the open-drain nature of the bus, if multiple modules are communicating on the same bus, as long as they are transmitting unique information, an inherent priority on the data line of LOW bits arises. For example, suppose two modules are attempting to negotiate a dynamic address simultaneously. At the first point in which a bit differs in their respective unique addresses, one of the modules will lose arbitration and reset its state, ceasing its own negotiation, allowing the other module to be assigned a dynamic address first. In an example scenario, assume a module A is transmitting 1111 and a module B is transmitting 1101 simultaneously. With reference to the first bit, if both modules write a HIGH (1) to the bus, both modules continue communicating on the bus. Similarly, with reference to the second bit, if both modules write a HIGH (1) to the bus, both modules continue communicating on the bus. With reference to the third bit, if module B writes a LOW (0) to the bus, module B “wins” over module A, which wrote a HIGH (1) to the bus. Module A notices that the bus does not match what module A is attempting to send. As a result, module A stops transmitting. The message received by core hub 106 so far is still consistent with what module B is transmitting (e.g., 110 . . . ).

Various implementations, because of this technique for dynamically assigning addresses to an arbitrary number of simultaneously connected modules, from a software perspective, hot-swap capability is automatically achieved in terms of communication on the bus. Active slaves can be used to facilitate the complex processes involved with dynamically changing the address using software. In some implementations, this could feasibly be achieved also with dumb slaves.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

In various implementations, the module connection lines connecting a module to bus 114 may include the following lines: a VBUS line (e.g., 3.3V˜5.0V nominal, 3.0V˜5.5V possibly practical, etc.), ground (GND), data line (e.g., I²C data line, SDA data line, etc.), clock line (e.g., I²C clock line, SCL, etc.), positive data terminal (DP) (USB Data), negative data terminal (DM) (USB Data), etc. In various implementations, the address layout or address space may be segmented as follows: 0x0A to 0x70—dynamic blocks address space, 0x7C—uninitialized module address, 0x7A—status address. The particular address layout may vary and will depend on the particular implementation.

In some implementations, when a new module is connected to the bus, the new module has a slave address of 0x7C (e.g., an uninitialized module address in place of its dynamic address) and 0x7A (e.g., its status address). As indicated herein, all modules have a general status address while active, and the status address is globally shared between the modules).

In various implementations, after modules have been added and initialized to bus 114 of system 100, each module listens on at least two addresses (e.g., I²C addresses, etc.) simultaneously during normal operation. In some implementations, normal operation may be post-initialization (e.g., after a given module is initialized on the bus). In some implementations, normal operation excludes time spent in sleep mode or deep sleep mode.

In some implementations, a dynamic address is assigned to a module at connection time. In some implementations, connection time is when the module initially connects to the bus. Also, in various implementations, the dynamic address is the primary method of data transmission between core hub 106 of core 102 and a given module. As indicated herein, in various implementations, the status address is a global address that is shared by all modules on the bus. The status address may be used for the purposes of reporting status and raising interrupts.

The following implementations are implemented using core 102, which is a master element in the modular system that initiates communication with modules, which are slave elements in the modular system.

As the master element, core 102 controls and manages communications and avoids collisions/conflicts when there are two or more modules that support the same data type or capability on the bus. This applies whether such modules are of the same module type or different module types. For example, if there are two LED modules connected to the bus, and the user requests “LED ON,” core hub 106 is responsible for negotiating and inferring which module to communicate with. The same applies if different modules of different module types both have the same capability (e.g., “LED ON”).

Implementations use minimal polling to facilitate high-speed and prioritized interrupt rising on the bus. This enables modules to be used for event detection at a high rate, which normally would not be possible on some buses such as I²C buses. Example applications may include button press detection on a module, GPS geo-fencing, etc.

As indicated herein, presuming that a fixed bus is used or that all dynamic addresses (e.g., I²C addresses) have already been resolved, each module on the bus is assigned to at least two hardware addresses on the same bus, where each module responds on both of the addresses during normal communication. Also, each module on the bus has a dynamic address on the bus. In some implementations, the dynamic address may be a fixed unique-on-the-bus address. As indicated herein, the dynamic address is unique to each module, and each module on the bus has a status address on the bus.

In some implementations, the status address is fixed, and is a common address that is shared by other modules. In some implementations, the status address is a common address that is globally shared by all other modules. The status address being shared may be referred to as an overloaded address. In some implementations, the status address may be the same address that an uninitialized module has when the uninitialized module is first connected to the bus.

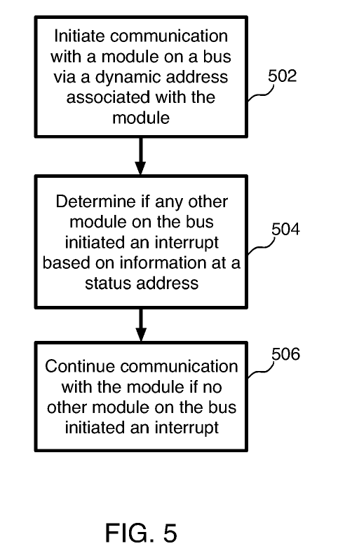

FIG. 5 illustrates an example flow diagram for facilitating communication in a modular system, according to some implementations. Referring to both FIGS. 1 and 5, a method is initiated at block 502, where core 102 initiates communication with a module on a bus such as module 104a. In various implementations, communication is initiated via a dynamic address that is associated with the module. For ease of illustration, this particular example presumes that core 102 is initiating communication with module 104a. For ease of illustration, these implementations are described in the context of one module. These implementations and others may also apply to module 104b and/or one or more other modules.

In various implementations, the initiating of the communication between core 102 and the module involves core 102 performing one or more write operations on the dynamic address that is associated with module 104a. Such write operations may include any write operations during normal operations (e.g., issuing commands, setting information, etc.). As indicated herein, within some various implementations, the dynamic address is a unique address that is associated with the module. In other words, each module is assigned a unique dynamic address, such that no two modules on the bus are assigned the same dynamic address.

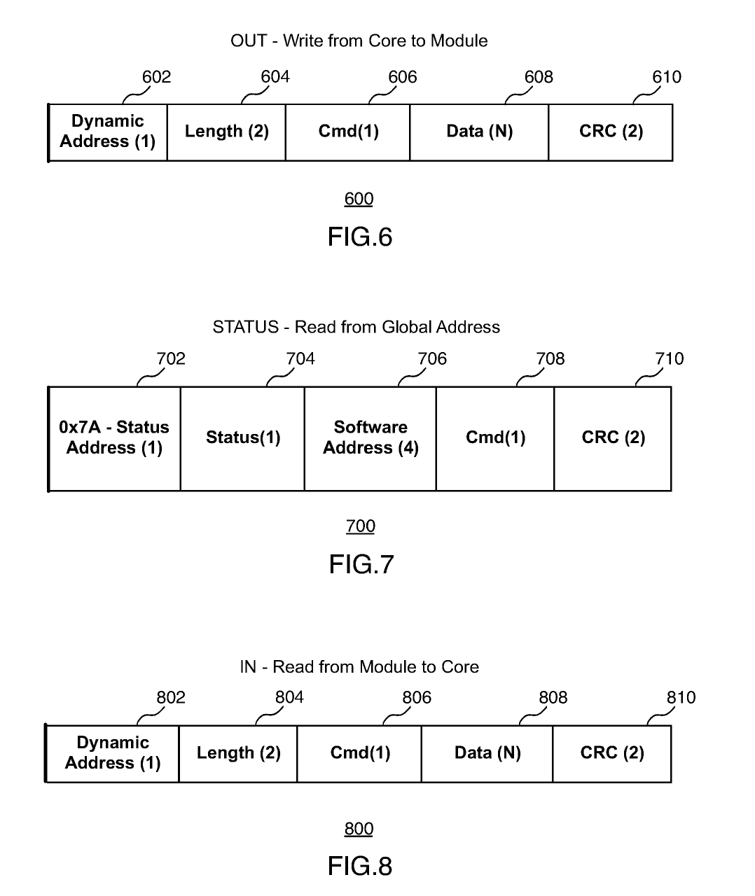

FIG. 6 illustrates an example data structure 600 in the context of a write operation, according to some implementations. Data structure 600 is an example out-going frame (e.g., a write from core 102 to module 104a) that may be use in some implementations. As shown, data structure 600 includes a dynamic address field 602, a length field 604, a command field 606, a data field 608, and a checksum field 610. The numbers in parenthesis are example numbers of bits per field, which may vary depending on the particular implementation. In some implementations, length field 604 indicates the length of the data that is to follow. In some implementations, command field 606 contains a command to call within the module. The command may be registered internally by the module and indicated within a header file associated with the module's driver. In some implementations, data field 608 contains the data to be passed as an argument. In some implementations, checksum field 610 contains checksum-bytes. Upon receiving data of data structure 600, the addressed module enters a ready-to-respond mode. In various implementations, data structure 600 may not have all of the fields shown and/or may have other fields instead of, or in addition to, those shown herein.

At block 504, core 102 determines if any other module on the bus initiated an interrupt, and core 102 makes the determination based on information at a status address. For example, in some implementations, to determine if any other module on the bus initiated an interrupt, core 102 performs a read operation on the status address, and core 102 reads the status from the status address. For example, core 102 may read the status address for an interrupt to determine whether an uninitialized module needs to be initialized. As indicated herein, in various implementations, the status address is a common or globally shared address that is shared among the modules (e.g., all of the modules).

At this point, if no interrupt has occurred, communication between core 102 and the module proceeds as normal. In some implementations, the status may be indicated by data of a predetermined size (e.g., one byte). If any module on the bus pulls a bit low on the status address, core 102 continues to read on the status address and also ascertains the dynamic address of the interrupting module. Core 102 may then handle the interrupt as would be appropriate.

FIG. 7 illustrates an example data structure 700 in the context of a status check operation, according to some implementations. Data structure 700 is an example in-coming status frame (e.g., a read from the global status address of module 104a to core 102) that may be used in some implementations. As shown, data structure 700 includes a status address field 702, a status field 704, a software address field 706, a command field 708, and a checksum field 710. In various implementations, a module provides a unique software address in software address field 706. In various implementations, data structure 700 may not have all of the fields shown and/or may have other fields instead of, or in addition to, those shown herein.

At block 506, core 102 continues communication with the module if no other module on the bus initiated an interrupt. In other words, core 102 continues communication with the module as long as there are no current interrupts, e.g., indicating that another module needs to be initialized.

In some implementations, before reading the status result from a particular module, core hub 106 first checks the global status address to determine if any other module on the bus initiated an interrupt. In some implementations, during normal operations, a module that is in ready-to-respond mode reports a status of 0xFE (e.g., normal responding status flag). In some implementations, if core hub 106 reads 0xFE from the status address, core hub 106 knows that no other module is attempting to raise an interrupt, and proceeds to perform a read operation from the module's dynamic address. The structure of the response is the same, and the command in the response is cross-referenced with the command called to check that it is responding in the correct way (e.g., the commands match). In some implementations, if a module on the bus attempts to raise an interrupt, when core hub 106 reads the status byte, it will be lower than 0xFE. As such, the module in ready-to-respond mode will have lost arbitration at this point, and will continue to wait to respond up to a timeout when the request will expire.

In various implementations, core 102 continues communication (e.g., exchanging information, receiving raw data, etc.) with the module by communicating (e.g., transferring information, etc.) via the dynamic address associated with the module. In some implementations, core 102 continues communication with the module by performing one or more read operations from the dynamic address associated with the module.

In some implementations, the communication is initiated with an initial write operation. The module enters a ready-to-respond mode and is aware that it is about to be read from. When the module responds, it responds with the requested data. In an example scenario, if core hub 106 writes a command such as WRITE (DYN_ADDR, GET_TEMPERATURE), the module collects the requested data ready and waits to be read from, e.g., T=GET_TEMPERATURE_DATA( ), ENTER_READY_TO_RESPOND_MODE(t). Core hub 106 then performs a read operation where the response is T, e.g., READ (DYN_ADDR).

FIG. 8 illustrates an example data structure 800 in the context of a read operation, according to some implementations. Data structure 800 is an example in-coming frame (e.g., a read from module 104a to core 102) that may be use in some implementations. As shown, data structure 800 includes a dynamic address field 802, a length field 804, a command field 806, a data field 808, and a checksum field 810. In various implementations, data structure 700 may not have all of the fields shown and/or may have other fields instead of, or in addition to, those shown herein.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

In some implementations, when a module needs to raise an active request rather than waiting to be polled, the module may hijack a portion of the status address. For example, the module may hijack a status byte when the global status address is read from by core hub 106.

In some implementations, when a module is replying to a normal data request, the status flag shall be set (e.g., 0xFE) indicating this is in a normal conversation. If the module needs to hijack a conversation, the module may interfere with any current communication to change the status flag. This will induce an arbitration loss.

In various implementations, the status flag has priority levels. This is inherent from the nature of wire- and logic of the bus (e.g., the I²C bus). At the first instance that a slave attempts to set the logic high on a data line (e.g., SDA data line) and the module is unable to set the logic high, the module will cease attempting to communicate and lose arbitration.

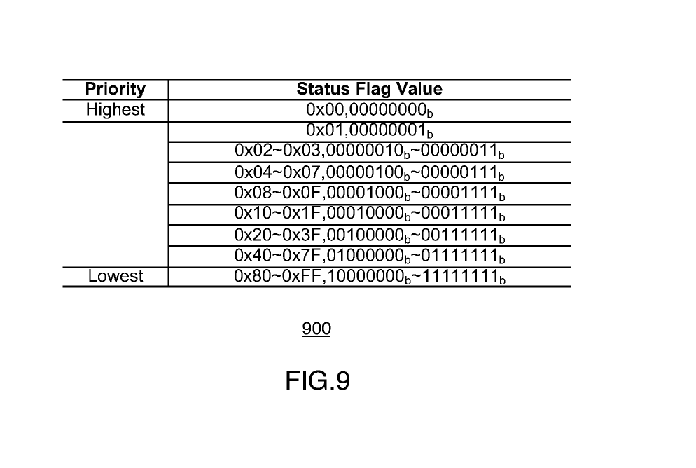

FIG. 9 illustrates an example priority table 900, according to some implementations. As shown, priority table 900 includes status flag values and associated priorities. In some implementations, each status flag value may be provisionally defined (e.g., 0xFE—normal responding status flag, 0x00—new module connected flag, etc.).

The following is an example process by which a module raises an interrupt, according to some implementations. The module waits for incidental communication on the bus between core hub 106 and any other module on the fixed address. When the target module starts to respond, the interrupting module hijacks the response status byte. This causes the original target module to lose arbitration. The module then transmits its software address and data related to the interrupt, which is to be handled by core hub 106. When core hub 106 recognizes that the status bit has been altered, core hub 106 handles the interrupt.

In the case of a module-connected event, the sequence proceeds as follows. Core hub 106 proceeds to register the new module's software address. Core hub 106 then generates and transmits a unique dynamic address to the module. The module sets its secondary I²C address to the dynamic address.

The following implementations are directed to module registration. Initially, in some implementations, a module listens on the status address (in order to raise an interrupt) instead of on its dynamic address (the default value of which is 0x7C—uninitialized).

After the module is connected on the bus, the module waits for the next point in time that core 102 checks the status of the bus (e.g., when core hub 106 of core 102 performs a READ operation from the status address), and core 102 issue a highest priority interrupt to signal that it requires initialization.

The module should then begin transmitting its unique software address, or unique blocks module identifier (UBMID), to core 102. In some implementations, each individual module is given a unique software address or ID when produced/manufactured. This ensures that this method works, since two uninitialized modules will not have the same initial software address. In some implementations, the software address is in the bytes immediately following the status byte that the module hijacked to perform the interrupt.

In various implementations, core 102 utilizes a slave arbitration mechanism if two modules are connected simultaneously. In some implementations, if a module successfully transmits its whole software address without losing arbitration in the process, the module determines that it is the only module that can have done so. The other slaves/modules would have certainly lost arbitration at some point before completing as the UBMIDs are unique and hence their values deviate at some point during transmission.

The module then begins listening on its dynamic address (e.g. the default uninitialized address 0x7C). Core hub 106 transmits first the UBMID it received (e.g., for checking by the module to confirm it is the intended recipient) followed by an I²C hardware address in the dynamic address space defined earlier. The module then switches its dynamic address to the address provided by core hub 106.

In some implementations, if a module loses arbitration while transmitting its software address, the module determines that there is another module that is also negotiating an address. The module that loses arbitration then stops attempting to communicate with core 102 and waits until the next status packet in order to attempt to raise an interrupt again.

In various implementations, core 102 requires modules 104a, 104b, etc. to have the capability of entering a sleep mode, or deep sleep mode, where the module reduces or slows down at least some of its functionality to conserver power. For example, in some implementations, while in sleep mode, the functions of some modules may be reduced to the function of being woken up. In some implementations, while in sleep mode, some modules may perform particular functionalities such as collecting data from one or more environment sensors, storing the data on board the local module MCU, and transferring the data to core 102 when woken up. In some implementations, core 102 instructs a given module to perform a deep sleep. The module de-registers its fixed-module address, which is the status address that it shares with all other non-sleeping modules on the bus. In various implementations, the module retains its dynamic address.

In some implementations, when modules enter a sleep mode, core hub 106 is aware of and remembers which modules are sleeping. When core hub 106 requires action from the module, core hub 106 can temporarily wake the module by communicating with the module's dynamic address. For example, core hub 106 temporarily wakes the module in order to enable the module to report its connection status. After serving the dynamic request, the module either returns to deep sleep mode or wakes up (e.g., if the wake command was sent to the module).

In various implementations, a modular communication framework facilitates two types of communication between higher-level application layer components and the modules, which are general communication and direct communication. With either type of communication, core 102 functions as a master device and the modules function as slave devices.

With regard to general communication, application developers may request certain types of data. Such data may include sensor data that is collected by sensors. As described in more detail herein, data types may include human vital sign data types such as heart rate, body temperature, etc. Data types may also include positioning data types types such as latitude, longitude, elevation, etc. Data types may also include command data types such as data input commands for lights, etc. In various implementations, core 102 serves data of a requested data type transparently or seamlessly in that core 102 serves such data to modules via the modular communication framework agnostically without the need for any specific knowledge of the hardware that is providing it.

With regard to direct communication, application developers may request to communicate directly with a given class of hardware. For example, application developers may communicate directly with particular hardware via core 102.

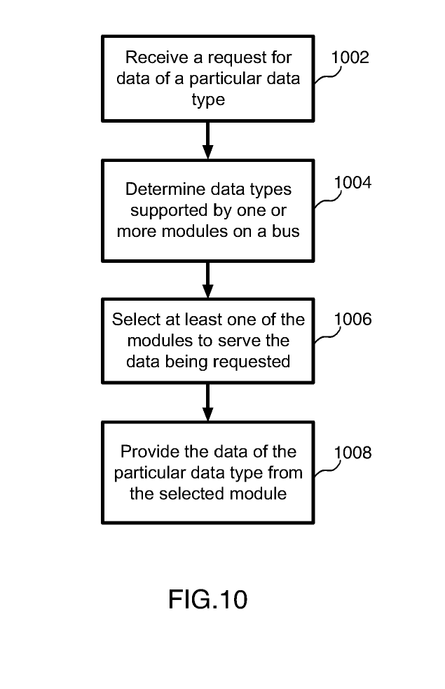

FIG. 10 illustrates an example flow diagram for facilitating general communication in a modular system, according to some implementations. Referring to both FIGS. 1 and 10, a method is initiated at block 1002, where core 102 receives a request for data of a particular data type. The data types may vary depending on the particular implementation. For example, in some implementations, the data types may include one or more vital sign data types. In some implementations, the data types may include one or more positioning data types. In some implementations, the data types may include one or more atmospheric data types.

At block 1004, core 102 determines data types supported by one or more respective modules on a bus. In some implementations, each module is associated with one or more sets of functions, and each set of functions includes at least one data type function that supports a predetermined data type. For example, if the data type is heart rate data, core 102 determines which modules support/provide heart rate data. In another example, if the data type is temperature, core 102 determines which modules support temperature data. It is possible that multiple modules support temperature data. As such, each module is associated with one or more data types.

In various implementations, core 102 determines the data types supported by one or more respective modules on the bus by receiving data type information from the modules. For example, in some implementations, core 102 receives, from each of the modules, a numbered list of functions.

In some implementations, the data type that is supported by a module may be communicated to core 102 when the module is first connected to the bus. As such, core 102 calls a function from that specific module at any point in order to receive data from that module. In some implementations, when core 102 receives a request for data, core 102 searches through the currently connected modules to determine whether any of them support the requested data type.

In an example scenario, suppose that the user has two temperature sensors connected, and the user goes to a temperature monitoring app on the device. If the data type that is supported by a module is communicated to core 102 when the module is first connected to the bus, core 102 would have recognized that there are two modules that can provide temperature data as soon as the two modules are connected. In some implementations, when the user requests data, the user can pre-select which sensor the user wants the data from.

If core 102 receives a request for temperature data and then searches through the currently connected modules to determine whether any of them support the requested data type, core 102 would scan to find a module that supports the data type (e.g., temperature data). In an example, if two modules that support the data type are detected, core 102 would then either provide the data from one or both modules based on a predetermined priority policy.

In some implementations, to determine the data types supported by the one or more respective modules, core 102 determines, for each of the modules, one or more associated sets of functions. Core 102 then determines, for each of the sets of functions, one or more data types. Those data types are supported by the respective modules.

At block 1006, core 102 selects at least one of the modules to serve the data being requested. In some implementations, each module registers a list of supported data types. The data types may be defined globally. As indicated herein, each data type may have an associated set of functions that also may be defined globally. These functions enable a given module to serve data of a given data type. For example, a function such as a get-temperature function may collect and serve temperature data. A function such as a calibrate-temperature-sensor function may calibrate a temperature function.

In various implementations, each module may also register an enumerated set of functions (e.g., a numbered list of functions) that the module may execute in order to serve or provide data of a particular data type. In various implementations, a given module may function to provide a particular set functions. For example, a module may function as a heart rate monitor with a set of functions that, for example, collect the current heart rate of a user. In another example implementation, a module may execute a set of functions that provide ornamental or decorative lights. Other implementations are possible.

These functions may be arbitrarily numbered to provide the enumerated list. Core 102, the master element, on the bus may call upon this list of functions, and retrieve data of a particular data type based on the function that supports the data type. Core 102 may, for example, call upon a particular function by number. In some implementations, a module developer may control modules and their respective functions via core 102.

In various implementations, modules may be wearable. For example, a module that is a heart rate monitor module may be worn on a wrist or other portion of a user. Such a heart rate monitor could collect data, which may be served based on instructions from core 102.

In an example scenario, when a developer requests to be served with a particular data type, core 102 may check the set of connected modules to see which ones support that data type. Core 102 then determines or selects which module will be used to serve the data type.

In some implementations, the selection of a module to serve the data is based on a predetermined priority policy. For example, in some implementations, a priority policy may be based on user preference or a user ranking. In some implementations, a priority policy may be based on availability. In some implementations, a priority policy may be based on performance.

At block 1008, core 102 provides the data of the particular data type from the selected module. In various implementations, core 102 transparently or seamlessly serves data of a requested data type to a requesting application. Serving of the data may be agnostic in that core 102 handles all initialization and standard function calls without involving the application developer. In some implementations, core 102 services the data based on a predetermined interval. For example, in some implementations, the interval may be user selected. In some implementations, the interval may be a default interval (e.g., every x milliseconds, etc.).

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

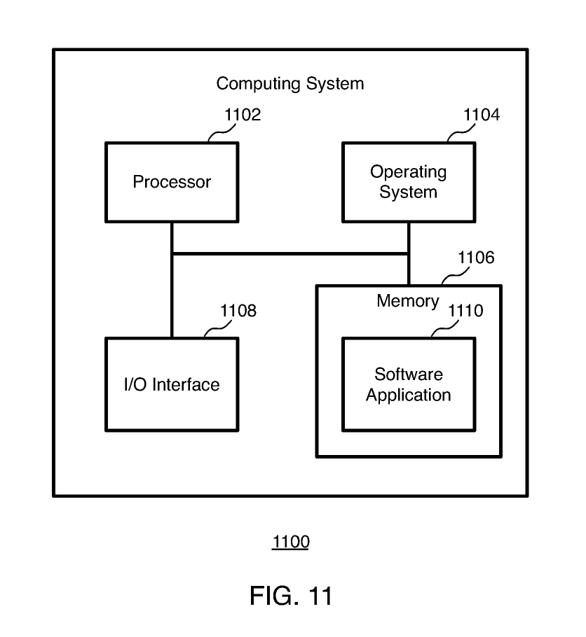

FIG. 11 illustrates a block diagram of an example computing system 1100, which may be used for some implementations described herein. For example, computing system 1100 may be used to implement any one or more of core 102, core hub 106, module 104a, and module 104b of FIG. 1, as well as to perform implementations described herein. In some implementations, computing system 1100 may include a processor 1102, an operating system 1104, a memory 1106, and an input/output (I/O) interface 1108.

In various implementations, processor 1102 may be used to implement various functions and features described herein, as well as to perform the method implementations described herein. While processor 1102 is described as performing implementations described herein, any suitable component or combination of components of computing system 1100 or any suitable processor or processors associated with computing system 1100 or any suitable system may perform the steps described. Implementations described herein may be carried out on a user device, on a server, or a combination of both.

In various implementations, computing system 1100 also includes a software application 1110, which may be stored on memory 1106 or on any other suitable storage location or computer-readable medium. Software application 1110 provides instructions that enable processor 1102 to perform the implementations described herein and other functions. Software application may also include an engine such as a network engine for performing various functions associated with one or more networks and network communications. The components of computing system 1100 may be implemented by one or more processors or any combination of hardware devices, as well as any combination of hardware, software, firmware, etc.

For ease of illustration, FIG. 11 shows one block for each of processor 1102, operating system 1104, memory 1106, I/O interface 1108, and software application 1110. These blocks 1102, 1104, 1106, 1108, and 1110 may represent multiple processors, operating systems, memories, I/O interfaces, and software applications. In various implementations, computing system 1100 may not have all of the components shown and/or may have other elements including other types of components instead of, or in addition to, those shown herein.

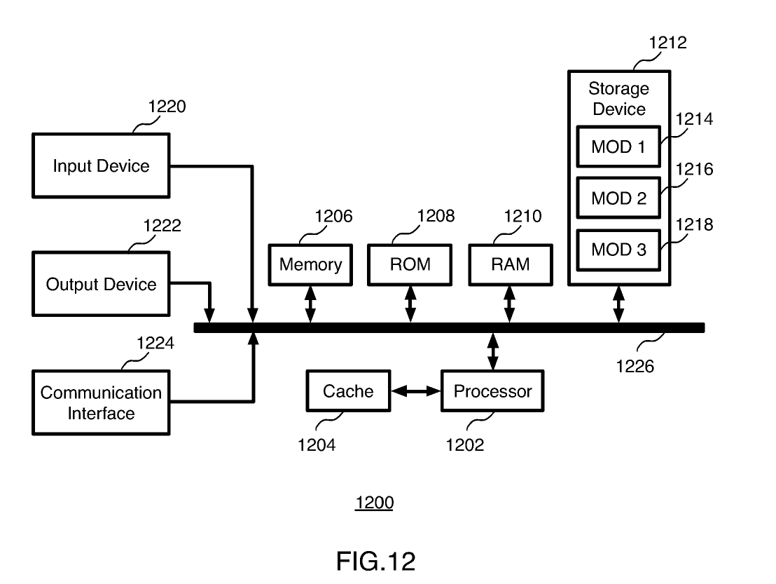

FIG. 12 illustrates a block diagram of an example computing system 1200, which may be used for some implementations described herein. For example, computing system 1200 may be used to implement any one or more of core 102, core hub 106, module 104a, and module 104b of FIG. 1, as well as to perform implementations described herein.

In some implementations, computing system 1200 may include a processor 1202, a cache 1204, a memory 1206, a read-only memory (ROM) 1208, a random-access memory (RAM) 1210, and a storage device 1212. As shown, storage device 1212 may include one or more modules 1214, 1216, 1218, etc. (labeled MOD1, MOD2, MOD3, etc.). Computing system 1200 also includes an input device 1220, an output device 1222, and a communication interface 1224. Computing system 1200 also includes a bus 1226 that connect the various components.

In various implementations, processor 1202 may be used to implement various functions and features described herein, as well as to perform the method implementations described herein. While processor 1202 is described as performing implementations described herein, any suitable component or combination of components of computing system 1200 or any suitable processor or processors associated with computing system 1200 or any suitable system may perform the steps described. Implementations described herein may be carried out on a user device, on a server, or a combination of both.

In various implementations, computing system 1200 may include a software application, which may be stored on memory 1206 or on any other suitable storage location or computer-readable medium. The software application provides instructions that enable processor 1202 to perform the implementations described herein and other functions. Software application may also include an engine such as a network engine for performing various functions associated with one or more networks and network communications. The components of computing system 1200 may be implemented by one or more processors or any combination of hardware devices, as well as any combination of hardware, software, firmware, etc.

For ease of illustration, FIG. 12 shows one block for each of the above-described elements. These blocks may represent multiple processors, operating systems, memories, I/O interfaces, and software applications. In various implementations, computing system 1200 may not have all of the components shown and/or may have other elements including other types of components instead of, or in addition to, those shown herein.

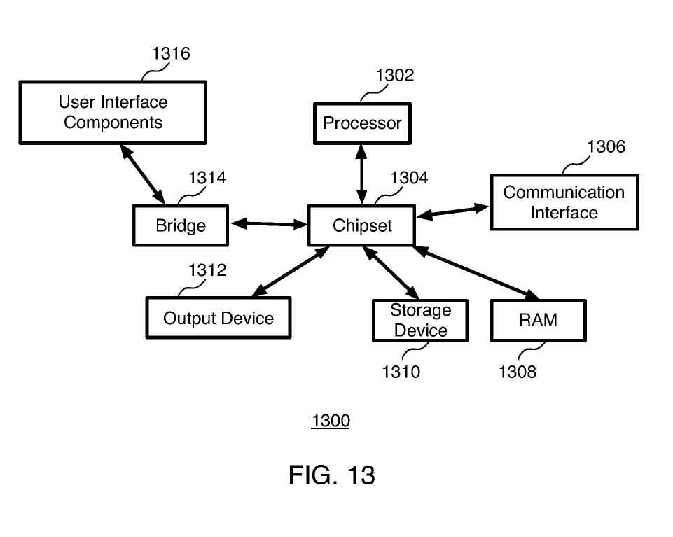

FIG. 13 illustrates a block diagram of an example computing system 1300, which may be used for some implementations described herein. For example, computing system 1300 may be used to implement any one or more of core 102, core hub 106, module 104a, and module 104b of FIG. 1, as well as to perform implementations described herein.

In some implementations, computing system 1300 may include a processor 1302, a chipset 1304, a communication interface 1306, and RAM 1308, a storage device 1310, an output device 1312, a bridge 1314, and one or more user interface components 1316.

In various implementations, processor 1302 may be used to implement various functions and features described herein, as well as to perform the method implementations described herein. While processor 1302 is described as performing implementations described herein, any suitable component or combination of components of computing system 1300 or any suitable processor or processors associated with computing system 1300 or any suitable system may perform the steps described. Implementations described herein may be carried out on a user device, on a server, or a combination of both.

In some implementations, computing system 1300 may include a software application, which may be stored on memory 1306 or on any other suitable storage location or computer-readable medium. The software application provides instructions that enable processor 1302 to perform the implementations described herein and other functions. Software application may also include an engine such as a network engine for performing various functions associated with one or more networks and network communications. The components of computing system 1300 may be implemented by one or more processors or any combination of hardware devices, as well as any combination of hardware, software, firmware, etc.

For ease of illustration, FIG. 13 shows one block for each of the above-described elements. These blocks may represent multiple processors, operating systems, memories, I/O interfaces, and software applications. In various implementations, computing system 1300 may not have all of the components shown and/or may have other elements including other types of components instead of, or in addition to, those shown herein.

Implementations described herein provide various benefits. For example, implementations directed to a module platform facilitate communication between the module and the core via a core hub. Implementations directed to a communication protocol facilitates communication between the core and the modules, facilitate both a high-speed and low-speed mode, permit for interrupts and module detection, and allow waking of modules which are in a sleeping state. Implementations directed to a modular framework manage the communication bus, manage communication with the modules, notifies the system of bus events, and provides access methods for sensors.

Although the description has been described with respect to particular embodiments thereof, these particular embodiments are merely illustrative, and not restrictive. Concepts illustrated in the examples may be applied to other examples and implementations.

In various implementations, software encoded is in one or more non-transitory computer-readable media for execution by one or more processors. The software when executed by one or more processors is operable to perform the implementations described herein and other functions.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a non-transitory computer-readable storage medium (also referred to as a machine-readable storage medium) for use by or in connection with the instruction execution system, apparatus, or device. Particular embodiments can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

Particular embodiments may be implemented by using a programmable general purpose digital computer, and/or by using application specific integrated circuits, programmable logic devices, field programmable gate arrays, optical, chemical, biological, quantum or nanoengineered systems, components and mechanisms. In general, the functions of particular embodiments can be achieved by any means as is known in the art. Distributed, networked systems, components, and/or circuits can be used. Communication, or transfer, of data may be wired, wireless, or by any other means.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (SaaS) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

For clarity of explanation, in some instances the present technology may be presented as including individual functional blocks including functional blocks including devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

For clarity of explanation, in some instances the present technology may be presented as including individual functional blocks including functional blocks comprising devices, device components, steps or routines in a method embodied in software, or combinations of hardware and software.

Note that in certain example implementations, the optimization and/or placement functions outlined herein may be implemented by logic encoded in one or more tangible, non-transitory media such as embedded logic provided in an application specific integrated circuit (ASIC), digital signal processor (DSP) instructions, software (potentially inclusive of object code and source code to be executed by a processor, or other similar machine, etc.). The computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

1. A method comprising:
detecting one or more modules connected to a bus, wherein the one or more modules are uninitialized;
associating the one or more modules with a status address on the bus;
polling for one or more interrupts on the status address; and
assigning one or more respective dynamic addresses to the one or more modules based on the one or more interrupts.

2. The method of claim 1, wherein the one or more modules are uninitialized if the one or more modules do not have dynamic addresses assigned to them.

3. The method of claim 1, wherein the status address is a globally shared address.

4. The method of claim 1, wherein the status address is a fixed address.

5. The method of claim 1, further comprising, responsive to the polling, receiving one or more polled interrupts from one or more of the respective modules.

6. The method of claim 1, further comprising, responsive to the polling, receiving one or more unique identifiers from the one or more respective modules.

7. The method of claim 1, wherein the one or more dynamic addresses are unique addresses.

8. A non-transitory computer-readable storage medium carrying program instructions thereon, the instructions when executed by one or more processors cause the one or more processors to perform operations comprising:
detecting one or more modules connected to a bus, wherein the one or more modules are uninitialized;
associating the one or more modules with a status address on the bus;
polling for one or more interrupts on the status address; and
assigning one or more respective dynamic addresses to the one or more modules based on the one or more interrupts.

9. The computer-readable storage medium of claim 8, wherein the one or more modules are uninitialized if the one or more modules do not have dynamic addresses assigned to them.

10. The computer-readable storage medium of claim 8, wherein the status address is a globally shared address.

11. The computer-readable storage medium of claim 8, wherein the status address is a fixed address.

12. The computer-readable storage medium of claim 8, wherein the instructions when executed further cause the one or more processors to perform operations comprising, responsive to the polling, receiving the one or more polled interrupts from one of the respective modules.

13. The computer-readable storage medium of claim 8, wherein the instructions when executed further cause the one or more processors to perform operations comprising, responsive to the polling, receiving one or more unique identifiers from the one or more respective modules.

14. The computer-readable storage medium of claim 8, wherein the one or more dynamic addresses are unique addresses.

15. A system comprising:
one or more processors; and
logic encoded in one or more non-transitory computer-readable storage media for execution by the one or more processors and when executed operable to perform operations comprising:
detecting one or more modules connected to a bus, wherein the one or more modules are uninitialized;
associating the one or more modules with a status address on the bus;
polling for one or more interrupts on the status address; and
assigning one or more respective dynamic addresses to the one or more modules based on the one or more interrupts.

16. The system of claim 15, wherein the one or more modules are uninitialized if the one or more modules do not have dynamic addresses assigned to them.

17. The system of claim 15, wherein the status address is a globally shared address.

18. The system of claim 15, wherein the status address is a fixed address.

19. The system of claim 15, wherein the logic when executed is further operable to perform operations comprising, responsive to the polling, receiving one or more polled interrupts from one or more of the respective modules.

20. The system of claim 15, wherein the logic when executed is further operable to perform operations comprising, responsive to the polling, receiving one or more unique identifiers from the one or more respective modules.

21-62. (canceled)
